(19) United States
(12) Patent Application Publication
(10) Pub. No.: US 2018/0069732 A1
(43) Pub. Date: Mar. 8, 2018

(54) TRANSMISSION APPARATUS AND DETECTION METHOD

(71) Applicant: FUJITSU LIMITED, Kawasaki-shi (JP)

(72) Inventor: Jun Sugawara, Tagajo (JP)

(73) Assignee: FUJITSU LIMITED, Kawasaki-shi (JP)

(21) Appl. No.: 15/641,291

(22) Filed: Jul. 4, 2017

(30) Foreign Application Priority Data
Sep. 2, 2016 (JP) 2016-172285

(51) Int. Cl. H04L 25/14; H04J 3/06; H04L 25/49

(52) U.S. Cl. CPC H04L 25/14; H04L 25/4908; H04J 3/06

(57) ABSTRACT

A transmission apparatus including: a first transferer that transfers first data including first identification information; a second transferer that transfers second data including second identification information; a detector that detects the first identification information from the first data transferred from the first transferer; and a storage that stores the second data transferred from the second transferer; wherein the detector detects the second identification information from the second data stored into the storage after detecting the first identification information from the first data.

### CROSS-REFERENCE TO RELATED APPLICATION

This application is based upon and claims the benefit of priority of the prior Japanese Patent Application No. 2016-172285, filed on Sep. 2, 2016, the entire contents of which are incorporated herein by reference.

### FIELD

A certain aspect of embodiments described herein relates to a transmission apparatus and a detection method.

### BACKGROUND

There is known a multilane distribution (MLD: Multi-Lane Distribution) system for transmitting data signals to a plurality of lanes (see e.g. International Publication Pamphlet No. 2012/144057, and Japanese Laid-open Patent Publication No. 2015-91094). Since a difference occurs between transmission rates of respective lanes in the multilane distribution system, a phase difference, i.e., a skew occurs between the data signals in the respective lanes.

To adjust the skew between the lanes, an alignment marker is inserted into the data signal in each lane. In a reception side, the alignment marker is detected by a detection circuit provided for each lane, and the skew between the respective lanes is adjusted based on detection timing thereof.

### SUMMARY

According to an aspect of the present invention, there is provided a transmission apparatus including: a first transferer that transfers first data including first identification information; a second transferer that transfers second data including second identification information; a detector that detects the first identification information from the first data transferred from the first transferer; and a storage that stores the second data transferred from the second transferer; wherein the detector detects the second identification information from the second data stored into the storage after detecting the first identification information from the first data.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a configuration diagram illustrating an example of a transmission system;

FIG. 2 is a diagram illustrating an example of the operation of a lane distribution part;

FIG. 3 is a configuration diagram illustrating a marker lock part and a deskew part according to a comparative example;

FIG. 4 is a timing chart illustrating the operation of the marker lock part according to the comparative example (part 1);

FIG. 5 is a timing chart illustrating the operation of the marker lock part according to the comparative example (part 2);

FIG. 6 is a timing chart illustrating an example of the operation of the deskew part;

FIG. 7 is a flowchart illustrating the operation of the marker lock part and the deskew part according to the comparative example;

FIG. 8 is a configuration diagram illustrating a marker lock part according to an embodiment;

FIG. 9 is a timing chart illustrating the operation of a receiver according to the embodiment;

FIG. 10 is a timing chart illustrating the operation of the marker lock part according to the embodiment;

FIG. 11 is a flowchart illustrating the operation of the receiver according to the embodiment;

FIG. 12 is a configuration diagram illustrating a marker lock part according to another embodiment;

FIG. 13 is a timing chart illustrating the operation of a receiver according to the another embodiment;

FIG. 14 is a timing chart illustrating the operation of the marker lock part according to the another embodiment; and

FIG. 15 is a flowchart illustrating the operation of the receiver according to the another embodiment.

### DESCRIPTION OF EMBODIMENTS

In the above-mentioned technique, since the detection circuit in each lane detects the alignment marker from parallel data obtained by converting the data signal, the detection circuit includes comparison circuits for a plurality of data patterns generated by shifting a pattern of the alignment marker in 1 (bit) unit. When the width of the parallel data of the data signal is 160 bits for example, comparison circuits for 160 data patterns are provided. Therefore, for example, when the number of lanes is 4, 640 (=160×4) comparison circuits are required. Thus, there is a problem that the more the number of lanes, the larger a circuit scale.

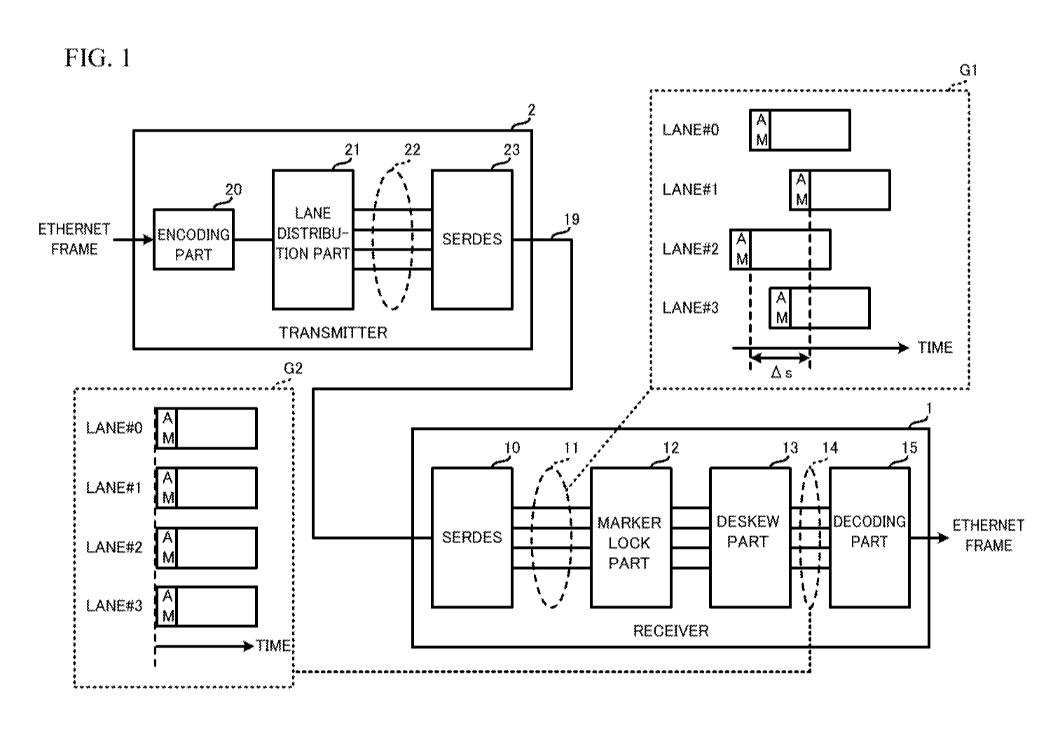

FIG. 1 is a configuration diagram illustrating an example of a transmission system. The transmission system includes a transmitter 2 transmitting a data signal, and a receiver 1 receiving the data signal. In the data signal, for example, an Ethernet frame is stored in a block unit. Here, the receiver 1 is an example of a transmission apparatus.

The transmitter 2 and the receiver 1 are connected to each other via a transmission path 19 such as an optical fiber. The transmitter 2 and the receiver 1 transmit the data signal according to a MLD (Multi-Lane Distribution) system, for example. Therefore, a plurality of lanes for transmitting the data signal are provided on the transmitter 2, the receiver 1 and the transmission path 19.

The transmitter 2 includes an encoding part 20, a lane distribution part 21 and a SERDES (Serializer/Deserializer) 23. Each of the encoding part 20, the lane distribution part 21 and the SERDES 23 is configured by a circuit such as a FPGA (Field Programmable gate array), for example.

The encoding part 20 64B/66B-encodes the Ethernet frame input from other device, as an example. Thereby, data in the Ethernet frame is encoded into 64B/66B blocks.

The lane distribution part 21 distributes the 64B/66B blocks to four lanes (#0 to #3) 22. There is no limit to the number of lanes 22.

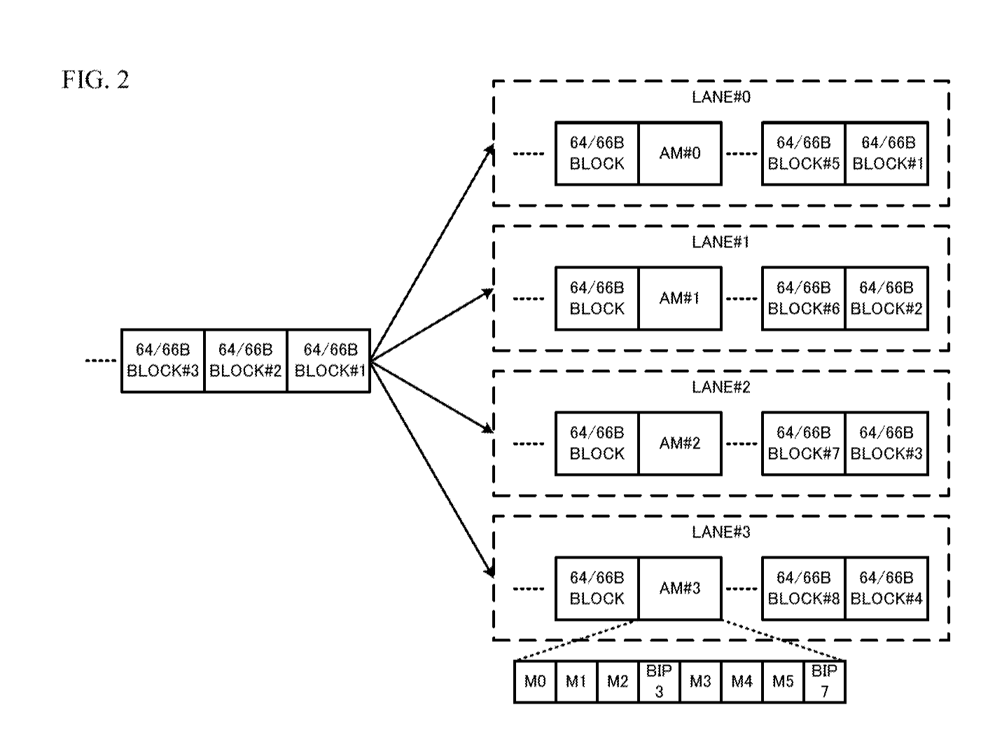

FIG. 2 is a diagram illustrating an example of the operation of the lane distribution part 21. The lane distribution part 21 distributes the 64B/66B blocks (#1, #2, #3, . . . ) to the lanes (#0 to #3) 22, respectively. As an example, the lane distribution part 21 distributes the 64B/66B blocks so as to evenly allocate them to each lane 22. Each lane 22 transfers the 64B/66B blocks distributed from the lane distribution part 21 to the SERDES 23.

Moreover, the lane distribution part 21 inserts alignment markers #0 to #3 into the same positions on a time axis with respect to the 64B/66B blocks of respective lanes 22. Each of the alignment markers #0 to #3 is an example of identification information for identifying the position of the data of each lane 22, and is used to adjust the skew between the lanes in the receiver 1. That is, the alignment markers #0 to #3 are synchronization information of the respective lanes 22.

Each of the alignment markers #0 to #3 includes data M0 to M5 each of which indicates a lane number, and BIPs (Bit Interleaved Parity) 3 and 7 each of which is a detection code of a data error. A data length of each of the alignment markers #0 to #3 is 64 bits in this example, but is not limited to this. Here, data M0 to M5 may be a common value regardless of the lane number.

Referring to FIG. 1 again, the SERDES 23 performs parallel-serial conversion on the 64B/66B block input from each lane 22, and outputs a conversion result to the transmission path 19 as the data signal. The SERDES 23 performs the parallel-serial conversion based on a ratio of the number of lanes 22 and the number of lanes in the transmission path 19. The data signal is input from the transmission path 19 to the receiver 1.

The receiver 1 includes a SERDES 10, a marker lock part 12, a deskew part 13 and a decoding part 15. Each of the SERDES 10, the marker lock part 12, the deskew part 13 and the decoding part 15 is configured by a circuit such as the FPGA, for example. Moreover, four lanes 11 and four lanes 14 for transmitting data of the data signal are provided in the receiver 1.

The SERDES 10 performs serial-parallel conversion on the data signal input from the transmission path 19, and outputs converted data signals to the marker lock part 12 via the lanes 11. The SERDES 10 performs the serial-parallel conversion based on a ratio of the number of lanes 11 and the number of lanes in the transmission path 19. Each of the lanes 11 transfers the data signal input from the SERDES 10 to the marker lock part 12.

A code G1 illustrates an example of the positions on the time axis of the alignment markers AM of the data signals in the lanes (#0 to #3) 11. Since a difference between the transmission rates of the respective lanes in the transmission path 19 occurs, skews Δs occur between the data signals in the lanes 11. In FIG. 1, only a single skew Δs between the lanes #1 and #2 is illustrated, but skews similarly exist between the other lanes 11.

The marker lock part 12 detects the alignment marker AM in each lane 11, and outputs information indicative of detection timing of the alignment marker AM along with the data signal to the deskew part 13. The deskew part 13 is an example of an adjuster, and adjusts the skews between the lanes (#0 to #3) 11 based on timings in which the alignment markers AM in the lanes 11 are detected. The deskew part 13 outputs the data signals in which the skews are adjusted, to the lanes (#0 to #3) 14, respectively. Each of the lanes (#0 to #3) 14 transfers the data signal input from the deskew part 13 to the decoding part 15.

A code G2 illustrates an example of the positions on the time axis of the alignment markers AM of the data signals in the lanes (#0 to #3) 14. The skews are adjusted by the deskew part 13, and hence the positions on the time axis of the alignment markers AM in the lanes (#0 to #3) 14 are aligned. That is, in the data signals in the lanes (#0 to #3) 14, phase differences are reduced by the skew adjustment.

The decoding part 15 extracts the 64B/66B blocks from the data signals input from the lanes (#0 to #3) 14 and decodes the 64B/66B blocks. The decoding part 15 generates the Ethernet frame by decoding and outputs the Ethernet frame to other device. Here, the lanes 22, 11 and 14 are formed with an electric conductor such as copper, as transmission paths of the data signals, for example.

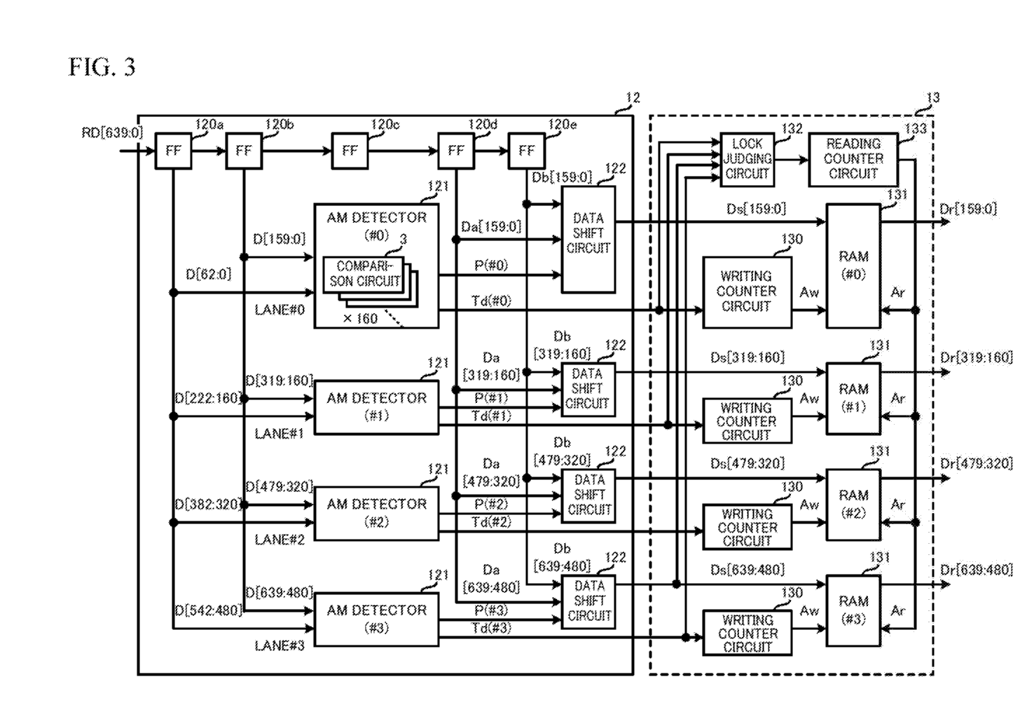

FIG. 3 is a configuration diagram illustrating the marker lock part 12 and the deskew part 13 according to a comparative example. The marker lock part 12 includes plural stages of flip-flops (FF: Flip-Flop) 120a to 120e, a plurality of alignment marker detectors (AM detector) (#0 to #3) 121, and a plurality of data shift circuits 122.

Data RD[639:0] of the data signals output from the preceding SERDES 10 is input to the FFs 120A to 120e. The data RD[639:0] is parallel data of 640 bits. Here, the RD[Na:Nb] (Na and Nb are positive integers, and Na>Nb) indicates that Nb-th to Na-th bits of the parallel data are included.

The lane #0 transfers data RD[159:0], and the lane #1 transfers data RD[319:160]. The lane #2 transfers data RD[479:320], and the lane #4 transfers data RD[639:480]. The data RD[639:0] is sequentially input to the FFs 120a to 120e in accordance with an unillustrated transmission clock signal. The FF 120a of a first stage and the FF 120b of a second stage output data D of a part of the data RD[639:0] to each of the AM detectors 121.

The FF 120a of the first stage outputs data D[62:0] to the AM detector (#0) 121 in the lane #0, and outputs data D[222:160] to the AM detector (#1) 121 in the lane #1. Moreover, the FF 120a of the first stage outputs data D[382:320] to the AM detector (#2) 121 in the lane #2, and outputs data D[542:480] to the AM detector (#3) 121 in the lane #3.

The FF 120b of the second stage outputs data D[159:0] to the AM detector (#0) 121 in the lane #0, and outputs data D[319:160] to the AM detector (#1) 121 in the lane #1. Moreover, the FF 120b of the second stage outputs data D[479:320] to the AM detector (#2) 121 in the lane #2, and outputs data D[639:480] to the AM detector (#3) 121 in the lane #3.

Thus, all bits of the data RD in each of the lanes #0 to #3 corresponding to each AM detector 121 are input from the FF 120b of the second stage to each AM detector 121, and further 63 bits data RD of a high-order side among subsequent data RD delayed from the data RD by one clock are input from the FF 120a of the first stage to each AM detector 121. Therefore, the alignment markers AM can be detected even if the alignment markers AM are accommodated in the parallel data corresponding to two continuous clocks without being accommodated in the parallel data corresponding to the same clock.

Each AM detector 121 detects the alignment marker AM from the data D transferred from each of the lanes #0 to #3. To detect the alignment marker AM, each AM detector 121 includes comparison circuits 3 for a plurality of data patterns generated by shifting a pattern of the alignment marker AM in 1 bit unit. When the width of the parallel data of the data signal is 160 bits for example, the comparison circuits 3 for 160 data patterns are provided in each AM detector 121 (see “×160”). Therefore, the number of comparison circuits 3 corresponding to all lanes is 640 (=160×4), and the circuit scale becomes large.

Each AM detector 121 generates detection signals Td (#0 to #3) each of which indicates timing (hereinafter referred to as “AM detection timing”) in which the alignment marker AM has been detected, and bit position signals P (#0 to #3) each of which indicates a position of a leading bit of the detected alignment marker AM. When the detection signal Td is “1” (a high level signal), the detection signal Td indicates that the alignment marker AM is detected. When the detection signal Td is “0” (a low level signal), the detection signal Td indicates that the alignment marker AM is not detected. Each AM detector 121 outputs the detection signal Td to the deskew part 13.

Moreover, the bit position signal P is a parallel signal having the same bit width (160 bits) as the data D. The bit position signal P [Bt] corresponding to the leading bit (Bt) of the alignment marker AM indicates “1” (a high level voltage), and the other bit position signal P indicates “0” (a low level voltage).

Moreover, a FF 120c of a third stage delays the data RD by a delay time of a detection process of the alignment marker AM by the AM detector 121. AFF 120d of a fourth stage and a FF 120e of a fifth stage output data Da and Db of parts of the data RD[639:0] to the data shift circuits 122 in the lanes #0 to #3, respectively. The data Da is data preceding the data Db by one clock.

The FF 120d of the fourth stage outputs the data Da[159:0] to the data shift circuit 122 in the lane #0, and outputs the data Da[319:160] to the data shift circuit 122 in the lane #1. Moreover, the FF 120d of the fourth stage outputs the data Da[479:320] to the data shift circuit 122 in the lane #2, and outputs the data Da[639:480] to the data shift circuit 122 in the lane #3.

The FF 120e of the fifth stage outputs the data Db[159:0] to the data shift circuit 122 in the lane #0, and outputs the data Db[319:160] to the data shift circuit 122 in the lane #1. The FF 120e of the fifth stage outputs the data Db[479:320] to the data shift circuit 122 in the lane #2, and outputs the data Db[639:480] to the data shift circuit 122 in the lane #3.

Thus, the data Da and Db corresponding to two continuous clocks are inputted from the FF 120d of the fourth stage and the FF 120e of the fifth stage to each data shift circuit 122, respectively. Therefore, it is possible to shift the data Da and Db so that the alignment markers AM are located at the head even if the alignment markers AM are accommodated in the parallel data corresponding to the two continuous clocks without being accommodated in the parallel data corresponding to the same clock.

The data shift circuit 122 shifts the data Da and Db so that the alignment markers AM are located at the head, based on the bit position signal P. The data shift circuit 122 outputs the data Ds after the shift to the deskew part 13.

The deskew part 13 includes a plurality of writing counter circuits 130, a plurality of RAMs (Random Access Memory) (#0 to #3) 131, a lock judging circuit 132 and a reading counter circuit 133. The writing counter circuit 130 is provided for each of the lanes #0 to #3. The detection signals Td (#0 to #3) are input from the AM detectors 121 of corresponding lanes #0 to #3 to the writing counter circuits 130, respectively.

Each writing counter circuit 130 begins to count a writing address Aw of the corresponding RAM 131 based on detection timing indicated by the detection signal Td. Thereby, each data DS output from each data shift circuit 122 is written to the corresponding RAM 131.

The lock judging circuit 132 judges whether to perform lock of the alignment marker AM based on each of the detection signals TD (#0 to #3) in the lanes #0 to #3. When the lock judging circuit 132 judges that two alignment markers AM are detected continuously for each of the lanes #0 to #3 based on each of the detection signals TD (#0 to #3) in the lanes #0 to #3, the lock judging circuit 132 locks the alignment markers. That is, the lock judging circuit 132 performs synchronization judgment of the alignment markers AM between the lanes #0 to #3. When the lock judging circuit 132 performs the lock of the alignment markers AM, the lock judging circuit 132 outputs a lock notification to the reading counter circuit 133.

When the lock notification is input, the reading counter circuit 133 begins to count a reading address Ar of the RAMs 131. The reading address Ar is common to the RAMs (#0 to #3) 131 in the lanes #0 to #3. Therefore, the stored data Ds is read as reading data Dr from each of the RAMs 131 in accordance with the count of the reading address Ar.

In the reading data Dr in each of the lanes #0 to #3, the alignment marker AM is located at the head. The reading data Dr in the lanes #0 to #3 are read simultaneously in accordance with the reading address Ar. Therefore, the reading data Dr in the lanes #0 to #3 are read from the RAMs 131 in a state where the leading alignment markers AM are aligned. In this way, the deskew part 13 adjusts the skews between the lanes #0 to #3 based on the detection timings of the alignment markers AM in the lanes #0 to #3. Here, the deskew part 13 is an example of the adjuster.

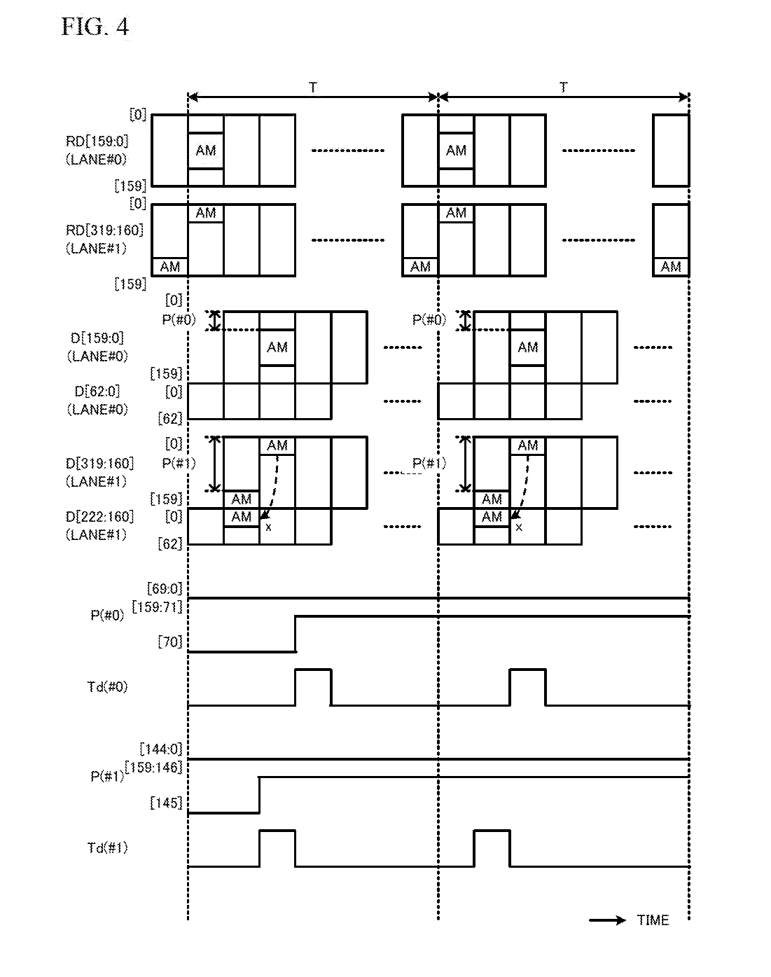

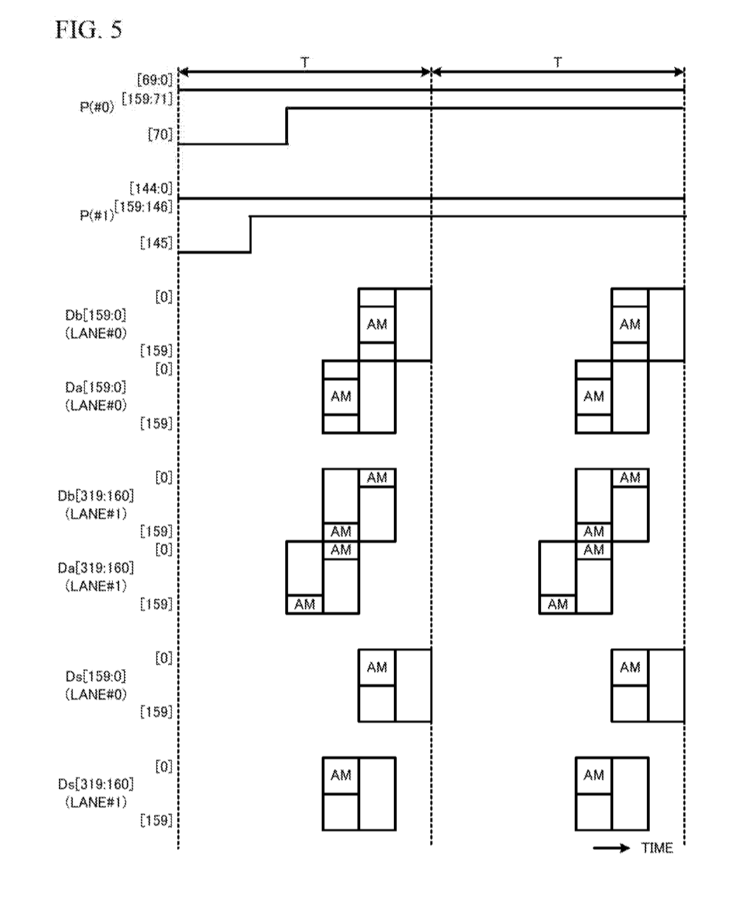

FIGS. 4 and 5 are timing charts illustrating the operation of the marker lock part 12 according to the comparative example. FIGS. 4 and 5 illustrate the operation relating to only the lanes #0 and #1, and the operation relating to the other lanes #2 and #3 is also performed in the same manner as the operation relating to the lanes #0 and #1. In FIGS. 4 and 5, the data Rd and D corresponding to one clock are indicated by rectangular frames, and the position of the alignment markers AM is indicated in the data Rd and D. In addition, a period T indicates a cycle of one frame of the data signal.

Referring to FIG. 4, the data RD[159:0] in the lane #0 is delayed by two clocks due to the FF 120a of the first stage and the FF 120b of the second stage by two clocks and is input from the FF 120b of the second stage to the AM detector 121 in the lane #0 as the data D[159:0]. The data D[62:0] delayed by one clock from the data D[159:0] is input from the FF 120a of the first stage to the AM detector 121 in the lane #0.

Moreover, the data RD[319:160] in the lane #1 is delayed by two clocks due to the FF 120a of the first stage and the FF 120b of the second stage, and is input from the FF 120b of the second stage to the AM detector 121 in the lane #1 as the data D[319:160]. The data D[222:160] delayed by one clock from the data D[319:160] is input from the FF 120a of the first stage to the AM detector 121 in the lane #1.

The alignment marker AM in the lane #0 is inserted into 70-130th bits in the data RD[319:160] as an example. Therefore, the AM detector (#0) 121 detects the alignment marker AM from the data D[70:130], and makes the detection signal Td (#0) into “1” at the detection timing.

Moreover, the AM detector (#0) 121 makes only the bit position signal P (#0) [70] corresponding to the leading bit of the alignment marker AM among the bit position signal P (#0) [159:0] into “1”.

Moreover, the alignment marker AM in the lane #1 is inserted into 145-159th bits in the data RD[319:160], and 0-62nd bits in the data RD[319:160] of a next clock cycle, as an example. Therefore, the AM detector (#0) 121 detects the alignment marker AM from the data D[319:160] from the FF 120b and the data D[222:160] from the FF 120a, and makes the detection signal Td (#1) into “1” at the detection timing. At this time, since the data D[319:160] from the FF 120b and the data D[222:160] from the FF 120a are combined into the parallel data corresponding to a single clock as indicated by a code “x” and the combined result is input to the AM detector 121, it is easy to detect the alignment marker AM.

Moreover, the AM detector (#1) 121 makes only the bit position signal P (#1) [145] corresponding to the leading bit of the alignment marker AM among the bit position signal P (#1) [159:0] into “1”.

Referring to FIG. 5, the data shift circuits 122 shift the data Da and Db corresponding to the two continuous clocks based on the bit position signals P (#0 and #1). More specifically, the data shift circuits 122 shift the data Da and Db by the number of bits corresponding to the bit position signals P (#0 and #1) to generate the data Ds that puts the alignment marker AM on the head (i.e., 0th bit). At this time, since the data Da of any clock cycle and the data Db of the next clock cycle are input to the data shift circuits 122 in a state where they are combined into the parallel data corresponding to the single clock, it is easy to perform data shift processing.

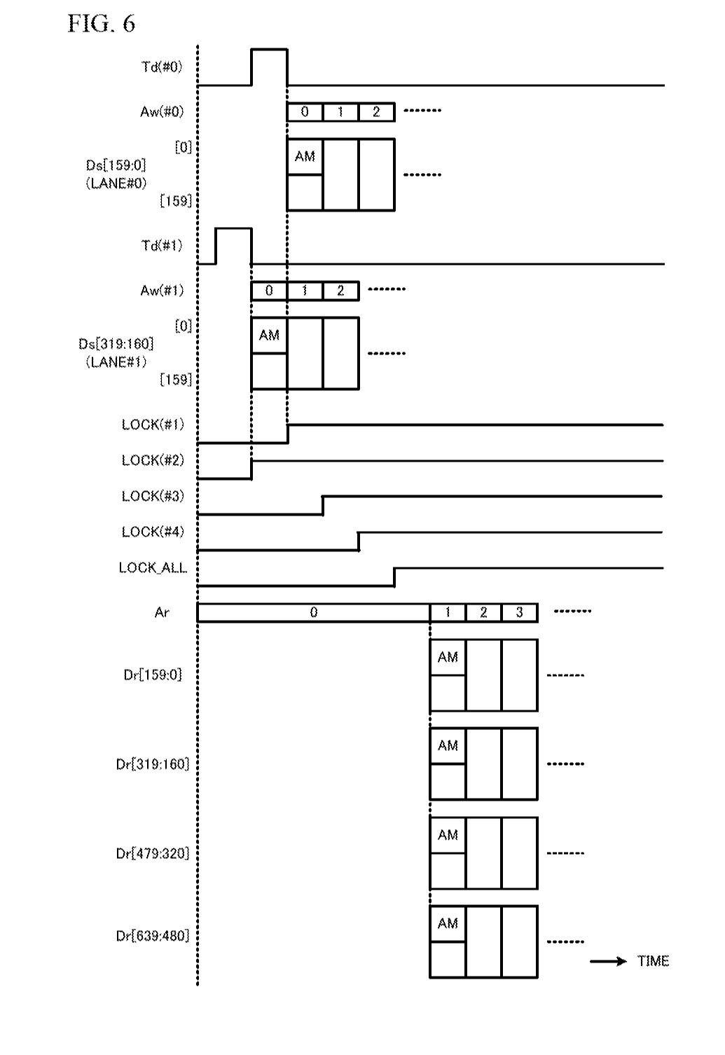

FIG. 6 is a timing chart illustrating an example of the operation of the deskew part 13. FIG. 6 illustrates writing operation of the data Ds relating to only the lanes #0 and #1, but the writing operation of the data Ds relating to the other lanes #2 and #3 is also performed in the same manner as the writing operation of the data Ds relating to the lanes #0 and #1.

Each writing counter circuit 130 generates the writing address Aw based on the detection diming indicated by the detection signal Td. More specifically, the writing counter circuit 130 loads “0” to a count value of the writing address Aw at a next clock cycle after the detection timing, and then counts the count value of the writing address Aw in accordance with the clock signal. With the update of the writing address Aw, the data Ds that puts the alignment marker AM on the head is written into the RAM 131. In this example, it is assumed that the writing address Aw is “0”, “1”, “2” or the like as an example.

The lock judging circuit 132 generates each of lock signals LOCK (#0 to #3) for each of the lanes #0 to #3 based on the detection timing indicated by the detection signal Td. When the alignment marker AM is detected from frames of the two continuous data signals, i.e., the detection signal Td is continuously “1” in the two frames, the lock judging circuit 132 makes the lock signals LOCK (#0 to #3) into “1” (a high voltage level) from “0” (a low voltage level). Here, in FIG. 6, the detection signal Td indicates the detection timing of the alignment marker AM in the second frame.

When the lock signals LOCK (#0 to #3) in all of the lanes #0 to #3 become “1”, the lock judging circuit 132 makes a lock notification signal LOCK ALL into “1” (the high voltage level) from “0” (the low voltage level). Thereby, the lock judging circuit 132 outputs the lock notification to the reading counter circuit 133.

When the lock notification signal LOCK ALL becomes “1”, the reading counter circuit 133 begins to count the reading address Ar. The reading address Ar is updated as “0”, “1”, “2” or the like according to a clock signal, for example. In accordance with the update of the read address AR, the reading data Dr that puts the alignment marker AM on the head is read from each RAM 131.

The reading data Dr in the lanes #0 to #3 are read from the RAMs (#0 to #3) 131 at the same timing, and are therefore output to the decoding part 15 of a subsequent stage in a state where the leading alignment markers AM are aligned.

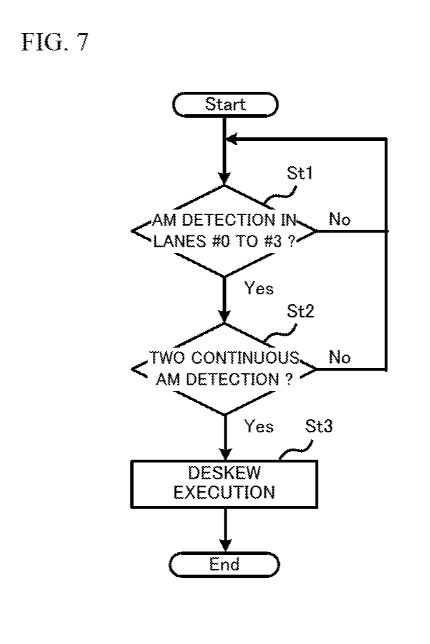

FIG. 7 is a flowchart illustrating the operation of the marker lock part 12 and the deskew part 13 according to the comparative example. The marker lock part 12 determines whether to have detected the alignment markers AM in the lanes #0 to #3 (step SU). When the marker lock part 12 does not have detected the alignment markers AM in the lanes #0 to #3 (No in step St1), the marker lock part 12 performs the processing of step St1 again.

When the marker lock part 12 has detected the alignment markers AM in the lanes #0 to #3 (Yes in step St1), the marker lock part 12 determines whether to have continuously twice detected the alignment markers AM in the each of the lanes #0 to #3, i.e., have detected the alignment markers AM in two continuous frames in the each of the lanes #0 to #3 (step St2). When the marker lock part 12 does not have continuously twice detected the alignment markers AM in the each of the lanes #0 to #3 (No in step St2), the marker lock part 12 performs the processing of step St1 again.

When the marker lock part 12 has continuously twice detected the alignment markers AM in the each of the lanes #0 to #3 (Yes in step St2), the deskew part 13 executes deskew processing (step St3). More specifically, the deskew part 13 reads the reading data Dr from the RAMs 131 in the lanes #0 to #3. In this way, the marker lock part 12 and the deskew part 13 according to the comparative example operate.

As described above, since the AM detector 121 is provided for each of the lanes #0 to #3, the circuit scale of the marker lock part 12 according to the comparative example becomes large.

Therefore, in the marker lock part 12 according to the embodiment, the AM detector 121 is shared between the plurality of lanes, and the data in other lanes is stored in a RAM while the alignment marker AM in a single lane being detected. The marker lock part 12 detects the alignment marker AM, reads the data stored in the RAM, and then detects the alignment marker AM in other lane. According to this configuration, it is possible to reduce the number of AM detectors 121 having a large circuit scale, and it is therefore possible to reduce the circuit scale of the receiver 1.

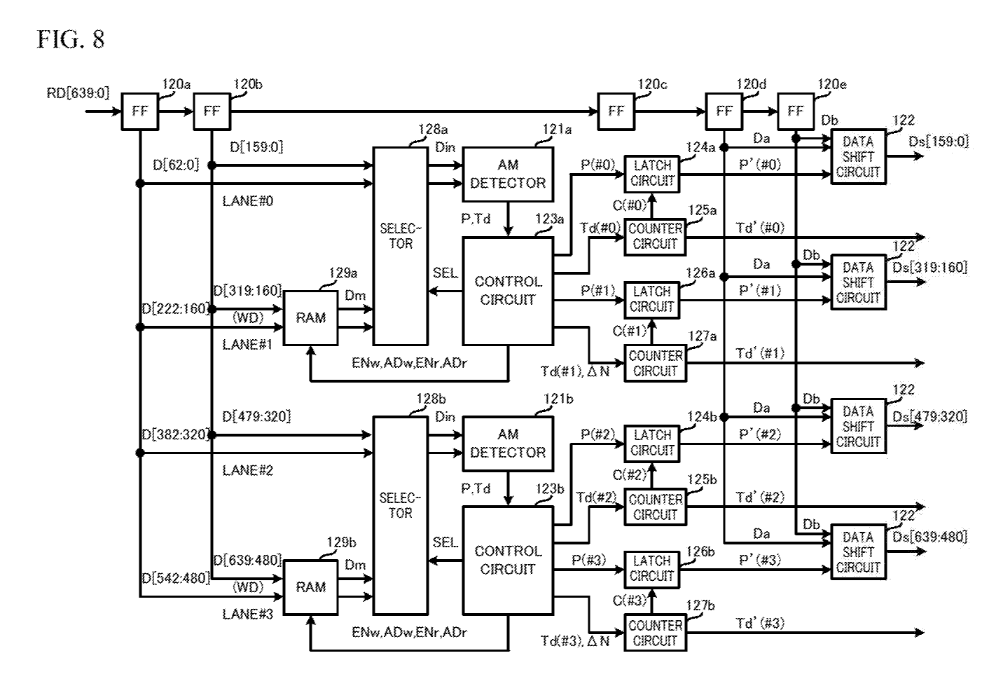

FIG. 8 is a configuration diagram illustrating the marker lock part 12 according to the embodiment. In FIG. 8, elements corresponding to those of FIG. 3 are designated by identical reference numerals, and description thereof is omitted. Here, the deskew part 13 according to the embodiment has the same configuration and function as that of the comparative example.

The marker lock part 12 includes the plural stages of FFs 120a to 120e, AM detectors 121a and 121b, the plurality of data shift circuits 122, selectors 128a and 128b, and RAMs 129a and 129b. The marker lock part 12 further includes control circuits 123a and 123b, latch circuits 124a, 124b, 126a and 126b, and counter circuits 125a, 125b, 127a and 127b.

Each of the AM detector 121a and 121b has the same configuration and function as the AM detector 121 of the comparative example. The AM detector 121a detects the alignment marker AM from the data D in the lane #0, and the AM detector 121b detects the alignment marker AM from the data D in the lane #2. Here, the AM detectors 121a and 121b are an example of the detector.

While the AM detector 121a is detecting the alignment marker AM from the data D in the lane #0, the data D in the lane #1 is written and stored into the RAM 129a. Moreover, while the AM detector 121b is detecting the alignment marker AM from the data D in the lane #2, the data D in the lane #3 is written and stored into the RAM 129b. Here, the RAMs 129a and 129b are an example of storages that store the data D transferred from the lanes #1 and #3. The storages are not limited to the RAMs 129a and 129b, and a storage device such as a hard disk drive may be used.

After the AM detector 121a detects the alignment marker AM from the data D in the lane #0, the AM detector 121a detects the alignment marker AM from the data D in the lane #0 stored into the RAM 129a. Moreover, after the AM detector 121b detects the alignment marker AM from the data D in the lane #2, the AM detector 121b detects the alignment marker AM from the data D in the lane #3 stored into the RAM 129b.

Thus, the AM detector 121a detects the alignment markers AM in the lanes #0 and #1, and the AM detector 121b detects the alignment markers AM in the lanes #2 and #3. Thereby, the AM detector 121a is shared between the lanes #0 and #1, and the AM detector 121b is shared between the lanes #2 and #3. Therefore, the number of AM detectors (121a, 121b) having the large circuit scale reduces more than that of the comparative example, which reduces the circuit scale of the receiver 1.

Here, in the present embodiment, the lanes #0 and #2 are an example of a first transferer, and the lanes #1 and #3 are an example of a second transferer. Moreover, the data [159:0] to be transferred by the lane #0 and the data [479:320] to be transferred by the lane #2 are an example of first data. The data [319:160] to be transferred by the lane #1 and the data [639:480] to be transferred by the lane #3 are an example of second data. Moreover, the alignment markers AM in the lanes #0 and #2 are an example of first identification information, and the alignment markers AM in the lanes #1 and #3 are an example of second identification information.

The data D in the lane #0 or the data D in the lane #1 is input to the AM detector 121a via the selector 128a, and the data D in the lane #2 or the data D in the lane #3 is input to the AM detector 121b via the selector 128b. The selector 128a connects the FFs 120a and 120b and the RAM 129a to the AM detector 121a, and the selector 128b connects the FFs 120a and 120b and the RAM 129b to the AM detector 121b.

The selector 128a selects data Din to be output to the AM detector 121a from the data D in the lane #0 or the data D in the lane #1 in accordance with a selection signal SEL input from the control circuit 123a. The selector 128b selects data Din to be output to the AM detector 121b from the data D in the lane #2 or the data D in the lane #3 in accordance with a selection signal SEL input from the control circuit 123b.

The control circuit 123a controls detection of the alignment markers AM in the lanes #0 and #1, and the control circuit 123b controls detection of the alignment markers AM in the lanes #2 and #3. More specifically, the control circuit 123a controls an order of the data D in the lanes #0 to #3 to be input to the AM detectors 121a and 121b by the selection signal SEL.

As the data Din to be input to the AM detector 121a, the control circuit 123a first selects the data D[159:0] in the lane #0 and then selects the data D[319:160] in the lane #1 after the detection of the alignment marker AM in the lane #0. As the data Din to be input to the AM detector 121b, the control circuit 123b first selects the data D[479:320] in the lane #2 and then selects the data D[639:480] in the lane #3 after the detection of the alignment marker AM in the lane #2.

Moreover, the control circuits 123a and 123b control the writing of writing data WD to the RAMs 129a and 129b and the reading of reading data Dm from the RAMs 129a and 129b. More specifically, the control circuit 123a controls the writing by outputting a wiring enable signal ENw and a writing address ADw to the RAM 129a, and controls the reading by outputting a reading enable signal ENr and a reading address ADr to the RAM 129a. The control circuit 123a stops the writing of the data D in the other lane #1 after the detection of the alignment marker AM in the lane #0.

Moreover, the control circuit 123b controls the writing by outputting a wiring enable signal ENw and a writing address ADw to the RAM 129b, and controls the reading by outputting a reading enable signal ENr and a reading address ADr to the RAM 129b. The control circuit 123b stops the writing of the data D in the other lane #3 after the detection of the alignment marker AM in the lane #2.

When the wiring enable signal ENw is “1” (a high level voltage), the data D in the lane #1 from the FFs 120a and 120b is written into the writing address ADw of the RAM 129a as the writing data WD. Moreover, when the reading enable signal ENr is “1” (a high level voltage), the data D in the lane #1 is read from the reading address ADr of the RAM 129a as the reading data Dm. The reading data Dm is input to the AM detector 121a via the selector 128a.

When the wiring enable signal ENw is “1” (a high level voltage), the data D in the lane #3 from the FFs 120a and 120b is written into the writing address ADw of the RAM 129b as the writing data WD. Moreover, when the reading enable signal ENr is “1” (a high level voltage), the data D in the lane #3 is read from the reading address ADr of the RAM 129b as the reading data Dm. The reading data Dm is input to the AM detector 121b via the selector 128b.

Moreover, the bit position signals P and the detection signals Td are input from the AM detectors 121a and 121b to the control circuits 123a and 123b. The control circuit 123a outputs the bit position signal P (#0) in the lane #0 to the latch circuit 124a, and outputs the bit position signal P (#1) in the lane #1 to the latch circuit 126a. Moreover, the control circuit 123a outputs the detection signal Td (#0) in the lane #0 to the counter circuit 125a, and outputs the detection signal Td (#1) in the lane #1 to the counter circuit 127a.

The control circuit 123b outputs the bit position signal P (#2) in the lane #2 to the latch circuit 124b, and outputs the bit position signal P (#3) in the lane #3 to the latch circuit 126b. Moreover, the control circuit 123b outputs the detection signal Td (#2) in the lane #2 to the counter circuit 125b, and outputs the detection signal Td (#3) in the lane #3 to the counter circuit 127b.

The counter circuits 125a and 127a adjust the delay of the alignment marker AM in the lane #1 generated by storing the data D into the RAM 129a. More specifically, the counter circuit 125a delays the detection signal Td (#0) of the alignment marker AM in the lane #0 by one frame. The counter circuit 127a delays the detection signal Td (#1) of the alignment marker AM in the lane #1 in accordance with a time difference between the alignment markers AM in the lanes #0 and #1, based on the delayed detection signal Td (#0) in the lane #0.

The counter circuit 125a delays a pulse (a region of “1”) of the detection signal Td (#0) by one frame of the data signal, and outputs the pulse to the writing counter circuit 130 of the deskew part 13 as a detection signal Td′ (#0). More specifically, when the pulse of the detection signal Td (#0) is input, the counter circuit 125a begins to count a counter value C (#0) according to the clock signal, and outputs a pulse of the detection signal Td′ (#0) when the counter value C (#0) becomes a counter value Cm of one frame.

Moreover, the counter circuit 127a acquires a phase difference ΔN between the alignment markers AM in the lanes #0 and #1 from the control circuit 123a, and loads a value shifted by the phase difference ΔN from the counter value C (#0) of the counter circuit 125a to a counter value C (#1) of the counter circuit 127a when the pulse of the detection signal Td (#1) in the lane #1 is input. The counter circuit 127a begins to count the counter value C (#1) from the loaded value, and outputs the pulse of the detection signal Td′ (#1) when the counter value C (#1) becomes the counter value Cm of one frame.

That is, the counter circuit 127a counts by shifting the number of clocks corresponding to the phase difference ΔN between the alignment markers AM. Therefore, in the counter circuit 127a, timing in which the counter value C (#1) becomes the counter value Cm is shifted by the number of clocks corresponding to the phase difference ΔN with respect to the counter circuit 125a. Thereby, the detection signals Td (#0) and Td (#1) are adjusted according to the number of clocks corresponding to the phase difference ΔN during a period of a next frame.

Moreover, the latch circuit 124a delays the bit position signal P (#0) in the lane #0 and outputs it to the data shift circuit 122 as the bit position signal P′ (#0). The latch circuit 124a acquires the counter value C (#0) from the counter circuit 125a, and outputs the bit position signal P′ (#0) when the counter value C (#0) becomes the Cm. Therefore, the bit position signal P′ (#0) is output at the same timing as the pulse of the detection signal Td′ (#0).

The latch circuit 126a delays the bit position signal P (#1) in the lane #1 and outputs it to the data shift circuit 122 as the bit position signal P′ (#1). The latch circuit 126a acquires the counter value C (#1) from the counter circuit 127a, and outputs the bit position signal P′ (#1) when the counter value C (#1) becomes the Cm. Therefore, the bit position signal P′ (#1) is output at the same timing as the pulse of the detection signal Td′ (#1).

On the other hand, the control circuit 123b outputs the bit position signal P (#2) in the lane #2 to the latch circuit 124b, and outputs the bit position signal P (#3) in the lane #3 to the latch circuit 126b. Moreover, the control circuit 123b outputs the detection signal Td (#2) in the lane #2 to the counter circuit 125b, and outputs the detection signal Td (#3) in the lane #3 to the counter circuit 127b.

The counter circuits 125b and 127b adjust the delay of the alignment marker AM in the lane #2 generated by storing the data D into the RAM 129b. More specifically, the counter circuit 125b delays the detection signal Td (#2) of the alignment marker AM in the lane #2 by one frame. The counter circuit 127b delays the detection signal Td (#3) of the alignment marker AM in the lane #3 in accordance with a time difference between the alignment markers AM in the lanes #2 and #3, based on the delayed detection signal Td (#2) in the lane #2. The counter circuits 125b and 127b perform the same operation as the above counter circuits 125a and 127a with respect to the lanes #2 and #3.

Moreover, the latch circuit 124b delays the bit position signal P (#2) in the lane #2 and outputs it to the data shift circuit 122 as the bit position signal P′ (#2). The latch circuit 126b delays the bit position signal P (#3) in the lane #3 and outputs it to the data shift circuit 122 as the bit position signal P′ (#3). The latch circuits 124b and 126b perform the same operation as the above latch circuits 124a and 126a with respect to the lanes #2 and #3.

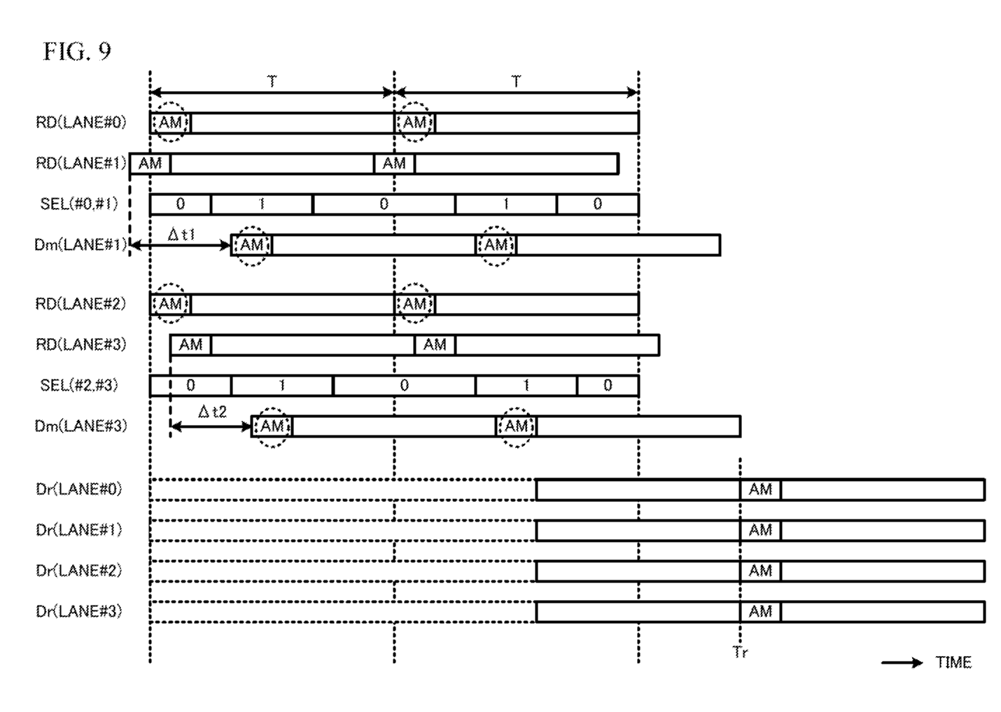

FIG. 9 is a timing chart illustrating the operation of the receiver 1 according to the embodiment. In the periods T of the two continuous frames, the AM detector 121a detects the alignment marker AM from the data RD in the lane #0 (see dotted circles). Moreover, the RAM 129a stores the data RD in the lane #1.

The control circuit 123a makes the selection signal SEL (#0, #1) into “0” so that the data RD in the lane #0 is input to the AM detector 121a. After the AM detector 121a detects the alignment marker AM in the lane #0, the control circuit 123a makes the selection signal SEL (#0, #1) into “1” so that the data RD in the lane #1 stored into the RAM 129a is input to the AM detector 121a.

In the periods T of the two continuous frames, the AM detector 121a detects the alignment marker AM in the lane #1 from the reading data Dm of the RAM 129a (see dotted circles). The alignment marker AM in the reading data Dm has a delay time Δt1 due to the RAM 129a against the alignment marker AM of the original data RD. Therefore, the counter circuits 125a and 127a adjust timings of the detection signals Td (#0) and Td (#1) based on the delay time Δt1.

In the periods T of the two continuous frames, the AM detector 121b detects the alignment marker AM from the data RD in the lane #2 (see dotted circles). Moreover, the RAM 129b stores the data RD in the lane #3.

The control circuit 123b makes the selection signal SEL (#2, #3) into “0” so that the data RD in the lane #2 is input to the AM detector 121b. After the AM detector 121b detects the alignment marker AM in the lane #2, the control circuit 123b makes the selection signal SEL (#2, #3) into “1” so that the data RD in the lane #2 stored into the RAM 129b is input to the AM detector 121b.

In the periods T of the two continuous frames, the AM detector 121b detects the alignment marker AM in the lane #2 from the reading data Dm of the RAM 129b (see dotted circles). The alignment marker AM in the reading data Dm has a delay time Δt2 due to the RAM 129b against the alignment marker AM of the original data RD. Therefore, the counter circuits 125b and 127b adjust timings of the detection signals Td (#2) and Td (#3) based on the delay time Δt2.

When the alignment marker AM in each of the lanes #0 to #3 is detected twice, the deskew part 13 outputs a common reading address Ar to the internal RAMs (#0 to #3) 131. When the output timing is assumed as “Tr”, the alignment markers AM are read from the RAMs (#0 to #3) 131 in the lanes #0 to #3 as the head of the reading data Dr at the timing Tr. Thereby, the deskew processing is performed on the data RD in the lanes #0 to #3.

Next, a description will be given of the adjustment of timings of the detection signals Td.

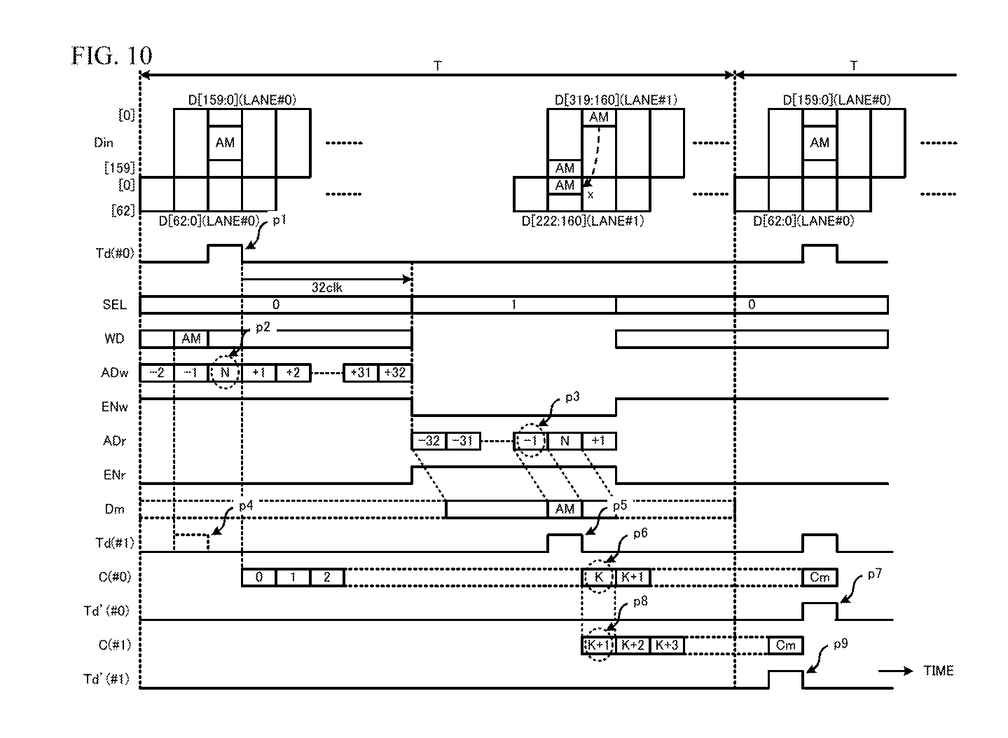

FIG. 10 is a timing chart illustrating the operation of the marker lock part 12 according to the embodiment. Here, FIG. 10 illustrates only signals relating to timing adjustment of the detection signals Td, and the other signals are described in FIGS. 4 to 6. Moreover, in the present example, only the timing adjustment of the detection signals Td (#0) and Td (#1) in the lanes #0 and #1 is illustrated, and the timing adjustment of the detection signals Td (#2) and Td (#3) in the lanes #2 and #3 is also performed in the same manner as the present example.

In the present example, it is assumed that the alignment marker AM in the lane #0 is later than the alignment marker AM in the lane #1 by one clock. Moreover, a storage area of the RAM 129a is 64 words as an example, but is not limited to this.

The control circuit 123a makes the selection signal SEL into “0” so that the data Din in the lane #0 is input to the AM detector 121a. The AM detector 121a detects the alignment marker AM in the lane #0 from the data Din, and outputs the pulse of the detection signal (#0) to the control circuit 123a (see a code “p1”).

The control circuit 123a outputs the writing enable signal ENw and the writing address ADw to the RAM 129a until the AM detector 121a detects the alignment marker AM in the lane #0, so that the writing data WD in the lane #0 is written into the RAM 129a. The control circuit 123a holds a value N (hereinafter referred to as “a reference address N”) of the writing address ADw at timing in which the pulse of the detection timing Td (#1) is input from the AM detector 121a (see a code “p2”). Here, in FIG. 10, the writing address ADw and the reading address ADr are indicated by an offset address (±1, ±2, . . . ) with respect to the reference address N.

After 32 clocks from timing in which the pulse of the detection signal Td (#1) is input (see “32 clk”), the control circuit 123a makes the writing enable signal into “0” from “1” to stop writing the writing data WD into the RAM 129a. Therefore, in the RAM 129a, the writing data WD in the lane #1 is written into an address space of ±32 words, centered on the reference address N. Therefore, when a single clock cycle is 6.2 (ns), for example, the deskew part 13 can adjust the skew within the range of ±198 (ns) (=6.2×32).

After making the writing enable signal ENw into “0”, the control circuit 123a makes the reading enable signal into “1” from “0”, and begins the output of the reading address ADr. The control circuit 123a counts up the reading address ADr from −32. Moreover, the control circuit 123a switches the selection signal SEL to “1” at timing in which the reading enable signal ENr is “1”. Thereby, the reading data Dm is read from the RAM 129a, and in input to the AM detector 121a as the data Din. Here, the reading data Dm delays from the reading address ADr by one clock and is input to the AM detector 121a.

The AM detector 121a detects the alignment marker AM in the lane #1 from the reading data Dm, and outputs the pulse of the detection signal Td (#1) at the timing (see a code “p5”). The pulse of the detection signal Td (#1) delays from the timing of the alignment marker AM in the original lane #1 (see a code “p4”). To adjust a delay, the counter circuit 125a adjusts the timing of the detection signal Td (#0) and makes it into the detection signal Td′ (#0), and the counter circuit 127a adjusts the timing of the detection signal Td (#1) and makes it into the detection signal Td′ (#1).

When the pulse of the detection signal Td (#0) is input from the AM detector 121a via the control circuit 123a, the counter circuit 125a begins to count the counter value C (#0) according to the clock signal. When the counter value C (#0) becomes Cm, the counter circuit 125a outputs the pulse of the detection signal Td′ (#0) (see a code “p7”). Here, the Cm corresponds to the number of clocks in one frame of the data signal. Therefore, the pulse of the detection signal Td′ (#0) delays from the pulse of the original detection signal Td (#0) by one frame, and is output to the writing counter circuit 130.

Moreover, when the pulse of the detection signal Td (#1) in the lane #1 is input from the AM detector 121a, the control circuit 123a detects the reading address ADr into which the alignment marker AM is stored. Since the reading data Dm delays from the reading address ADr by one clock, the control circuit 123a detects the reading address ADr before one clock from the alignment marker AM in the reading data Dm. In the present example, the alignment marker AM in the lane #1 is earlier than the alignment marker AM in the lane #0 by one clock on a time axis, and therefore “−1” is detected as the reading address ADr (see a code “p3”).

After the control circuit 123a detects the reading address ADr corresponding to the alignment marker AM in the lane #1, the control circuit 123a makes the writing enable signal ENw into “1” again. Thereby, the data D in the lane #1 begins to be stored into the RAM 129a again.

Moreover, the control circuit 123a outputs the reading address ADr corresponding to the alignment marker AM in the lane #1 to the counter circuit 127a as the phase difference ΔN with respect to the reference address N. When the pulse of the detection signal Td (#1) is input from the AM detector 121a via the control circuit 123a, the counter circuit 127a acquires the counter value C (#0) from the counter circuit 125a, and loads a value shifted by the phase difference ΔN from the counter value C (#0), to the counter value C (#1) of the counter circuit 127a.

In the present example, the phase difference ΔN is “−1”. Therefore, when the counter value C (#0) in a next clock cycle when the pulse of the detection signal Td (#1) is input is K (a positive integer) (see a code “p6”) for example, “K+1” is loaded to the counter value C (#1) (see a code “p8”). That is, a value earlier by one clock than the counter value C (#0) is loaded to the counter value C (#1).

When the counter value C (#0) becomes the Cm, the counter circuit 125a outputs the pulse of the detection signal Td′ (#0) in the lane #0 (see a code “p7”). Therefore, the pulse of the detection signal Td (#0) in the lane #0 is delayed by one frame and is output.

When the counter value C (#1) becomes the Cm, the counter circuit 127a outputs the pulse of the detection signal Td′ (#1) in the lane #1 (see a code “p9”). Since the counter value C (#1) is earlier by one clock than the counter value C (#0) depending on the phase difference ΔN, the pulse of the detection signal Td′ (#1) in the lane #1 is output earlier by one clock than the detection signal Td′ (#0) in the lane #0. Thereby, the delay of the data RD in the lane #1 is adjusted.

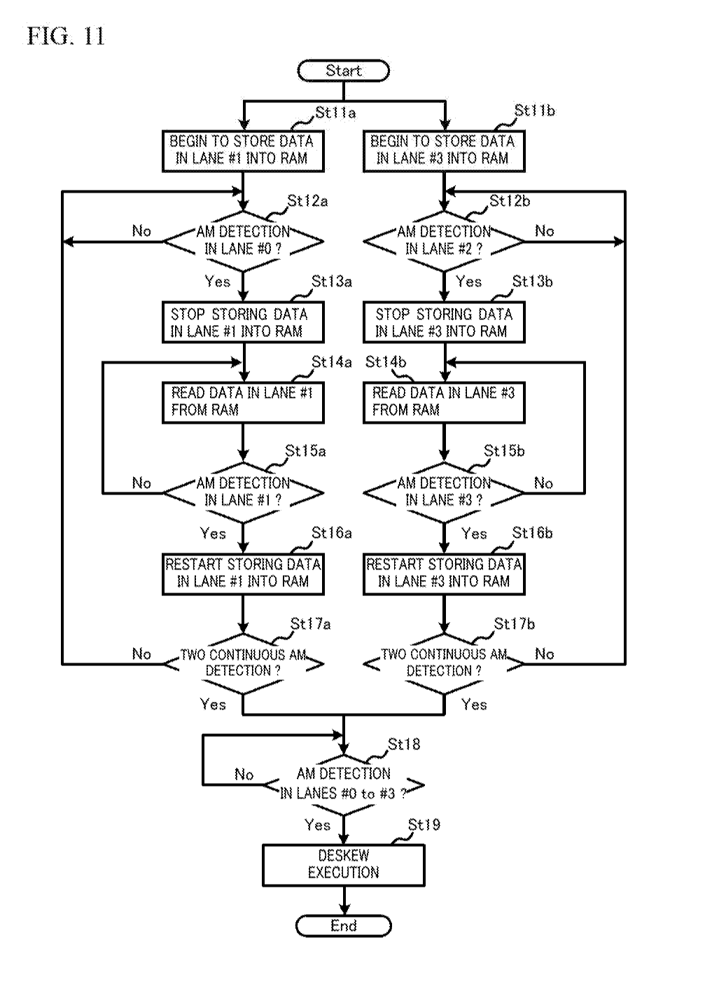

FIG. 11 is a flowchart illustrating the operation of the receiver 1 according to the embodiment. Steps St11a to St17a are processing relating to the lanes #0 and #1, and steps St11b to St17b are processing relating to the lanes #2 and #3. Each processing of steps St11a to St17a and each processing of step St11b˜St17b are executed concurrently.

With respect to the lanes #0 and #1, the control circuit 123a begins to store the data D (the writing data WD) in the lane #1 into the RAM 129a according to the writing enable signal ENw and the writing address ADw (step St11a). Next, the control circuit 123a determines whether the alignment marker AM in the lane #0 is detected based on the detection signal Td from the AM detector 121a (step St12a). When the alignment marker AM in the lane #0 is not detected (No in step St12a), the processing of step St12a is performed again.

When the alignment marker AM in the lane #0 is detected (Yes in step St12a), the control circuit 123a stops storing the data D in the lane #1 into the RAM 129a according to the writing enable signal ENw (step St13a). Next, the control circuit 123a reads the data D (the reading data Dm) in the lane #1 from the RAM 129a according to the reading enable signal ENr and the reading address ADr (step St14a). The readout data RD in the lane #1 is input to the AM detector 121a.

Next, the control circuit 123a determines whether the alignment marker AM in the lane #1 is detected based on the detection signal Td from the AM detector 121a (step St15a). When the alignment marker AM in the lane #1 is not detected (No in step St15a), the processing of step St14a is performed again.

When the alignment marker AM in the lane #1 is detected (Yes in step St15a), the control circuit 123a restarts storing the data D (the writing data WD) in the lane #1 into the RAM 129a according to the writing enable signal ENw and the writing address ADw (step St16a). Next, the lock judging circuit 132 determines whether the alignment markers AM in the lanes #0 and #1 are detected in the two continuous frames based on the respective pulses of the detection signals Td′ (#0) and Td′ (#1) (step St17a).

When the alignment markers AM in the lanes #0 and #1 are not detected in the two continuous frames (No in step St17a), the processing of step St12a is performed again. On the other hand, when the alignment markers AM in the lanes #0 and #1 are detected in the two continuous frames (Yes in step St17a), the processing of step St18 is performed.

On the contrary, with respect to the lanes #2 and #3, the control circuit 123b begins to store the data RD (the writing data WD) in the lane #3 into the RAM 129b according to the writing enable signal ENw and the writing address ADw (step St11b).

Next, the control circuit 123b determines whether the alignment marker AM in the lane #2 is detected based on the detection signal Td from the AM detector 121b (step St12b). When the alignment marker AM in the lane #2 is not detected (No in step St12b), the processing of step St12b is performed again.

When the alignment marker AM in the lane #2 is detected (Yes in step St12b), the control circuit 123b stops storing the data RD in the lane #3 into the RAM 129b according to the writing enable signal ENw (step St13b). Next, the control circuit 123b reads the data RD (the reading data Dm) in the lane #3 from the RAM 129b according to the reading enable signal ENr and the reading address ADr (step St14b). The readout data RD in the lane #3 is input to the AM detector 121b.

Next, the control circuit 123b determines whether the alignment marker AM in the lane #3 is detected based on the detection signal Td from the AM detector 121b (step St15b). When the alignment marker AM in the lane #3 is not detected (No in step St15b), the processing of step St14b is performed again.

When the alignment marker AM in the lane #3 is detected (Yes in step St15b), the control circuit 123b restarts storing the data RD (the writing data WD) in the lane #3 into the RAM 129b according to the writing enable signal ENw and the writing address ADw (step St16b). Next, the lock judging circuit 132 determines whether the alignment markers AM in the lanes #2 and #3 are detected in the two continuous frames based on the respective pulses of the detection signals Td′ (#2) and Td′ (#3) (step St17b).

When the alignment markers AM in the lanes #2 and #3 are not detected in the two continuous frames (No in step St17b), the processing of step St12b is performed again. On the other hand, when the alignment markers AM in the lanes #2 and #3 are detected in the two continuous frames (Yes in step St17b), the processing of step St18 is performed.

Next, the lock judging circuit 132 determines whether the alignment marker AM in each of the lanes #0 to #3 is detected twice (step St18). When the alignment marker AM in each of the lanes #0 to #3 is not detected twice (No in step St18), the processing of step St18 is performed again.

When the alignment marker AM in each of the lanes #0 to #3 is detected twice (Yes in step St18), the reading counter circuit 133 outputs the reading address to the RAMs (#0 to #3) 131 in the lanes #0 to #3, to thereby execute the deskew processing (step St19). In this way, the receiver 1 operates.

In the present embodiment, each of the AM detectors 121a and 121b is shared for every two lanes in the lanes #0 to #3, but a single AM detector may be shared between all the lanes #0 to #3. In this case, since the number of AM detectors is the half of the number of AM detectors in the present embodiment, the time required for detection of the alignment marker AM increases, but it is possible to reduce the circuit scale compared with the present embodiment.

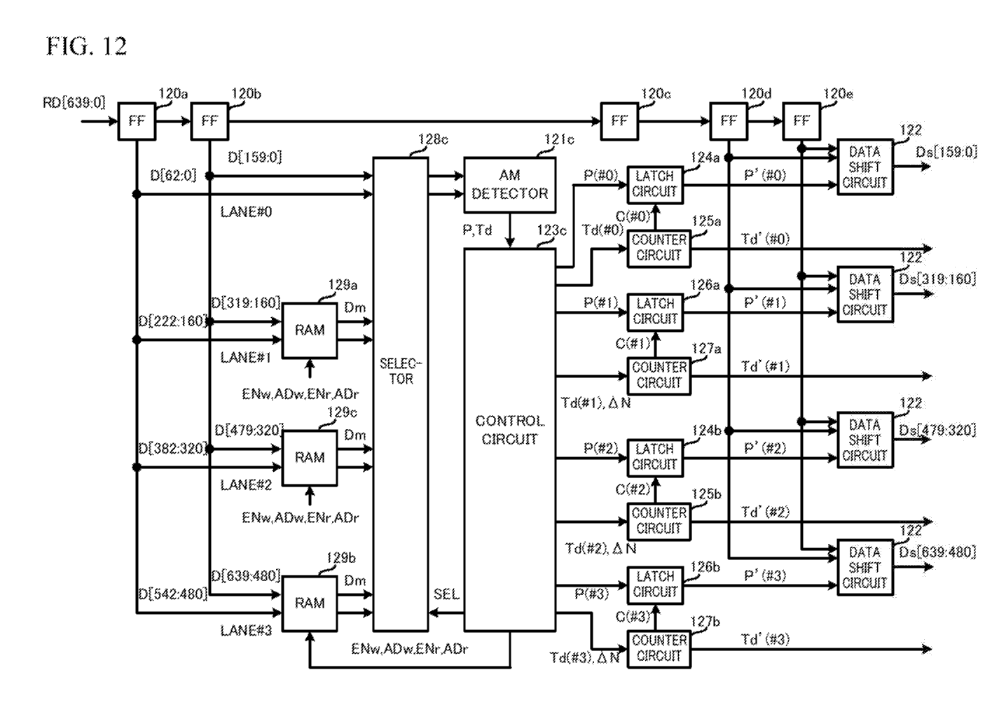

FIG. 12 is a configuration diagram illustrating the marker lock part 12 according to another embodiment. In FIG. 12, elements corresponding to those of FIG. 8 are designated by identical reference numerals, and description thereof is omitted.

The marker lock part 12 includes the plural stages of FFs 120a to 120e, the AM detectors 121a and 12b, the plurality of data shift circuits 122, the selectors 128a and 128b, and the RAMs 129a and 129b. The marker lock part 12 further includes a control circuit 123c, the latch circuits 124a, 124b, 126a and 126b, and the counter circuits 125a, 125b, 127a and 127b.

Since in the present embodiment, compared with the previous embodiment of FIG. 8, a RAM 129c that stores the writing data WD of the lane #3 is added, the single AM detector 121c can detect the alignment markers AM in all of the lanes #0 to #3. The AM detector 121c has the same configuration and function as the AM detector 121 of the comparative example. The AM detector 121c sequentially detects the alignment markers AM from the data D in the lanes #0 to #3. Here, the AM detector 121c is an example of the detector.

While the AM detector 121c is detecting the alignment marker AM from the data D in the lane #0, the data in the lanes #1 to #3 are written and stored into the RAMs 129a to 129c, respectively. Here, the RAMs 129a to 129c are an example of the storages. The storages are not limited to the RAMs 129a to 129c, and the storage device such as the hard disk drive may be used.

After detecting the alignment marker AM from the data D[159:0] in the lane #0, the AM detector 121c detects the alignment marker AM from the data D[319:160] in the lane #1 stored into the RAM 129a. After detecting the alignment marker AM from the data D[319:160] in the lane #1, the AM detector 121c detects the alignment marker AM from the data D[479:320] in the lane #2 stored into the RAM 129c. Moreover, after detecting the alignment marker AM from the data D[479:320] in the lane #2, the AM detector 121c detects the alignment marker AM from the data D[639:480] in the lane #3 stored into the RAM 129b.

Here, the lane #0 is an example of a first transferer, the lane #1 is an example of a second transferer, and the lane #2 is an example of a third transferer. The data D[159:0] to be transferred by the lane #0 is an example of first data, the data D[319:160] to be transferred by the lane #1 is an example of second data, and the data D[479:320] to be transferred by the lane #2 is an example of third data. Moreover, the alignment markers AM in the lane #0 is an example of first identification information, the alignment markers AM in the lane #1 is an example of second identification information, and the alignment markers AM in the lane #2 is an example of third identification information.

Thus, the AM detector 121c sequentially detects the alignment markers AM in the lanes #0 to #3. Thereby, the AM detector 121c is shared between all of the lanes #0 to #3. Therefore, the number of AM detectors 121c having the large circuit scale reduces compared with the previous embodiment, and hence the circuit scale of the receiver 1 is further reduced.

The data D in any one of the lanes #0 to #3 is input to the AM detector 121c via the selector 128c. The selector 128c connects the FFs 120a and 120b and the RAMs 129a to 129c to the AM detector 121c. The selector 128c selects the data Din to be output to the AM detector 121c from the data D in all of the lanes #0 to #3 in accordance with the selection signal SEL input from the control circuit 123c.

As with the control circuits 123a and 123b, the control circuit 123c controls the detection of the alignment markers AM in the lanes #0 to #3, the writing of the data D into the RAMs 129a to 129c, and the reading of the data D from the RAMs 129a to 129c. Moreover, as with the control circuits 123a and 123b, the control circuit 123c performs delay processing of the detection signals Td (#0) to Td (#3) of the alignment markers AM.

The control circuit 123c controls an order of the data D in the lanes #0 to #3 to be input to the AM detector 121c by the selection signal SEL. The control circuit 123c outputs the selection signal SEL so that the data D is input to the AM detector 121c in an order of the lanes #0 to #3.

More specifically, as the data Din to be input to the AM detector 121c, the control circuit 123c first selects the data D[159:0] in the lane #0, and selects the data D[319:160] in the lane #1 after the detection of the alignment marker AM in the lane #0. As the data Din to be input to the AM detector 121c, the control circuit 123c selects the data D[479:320] in the lane #2 after the detection of the alignment marker AM in the lane #1, and selects the data D[639:480] in the lane #3 after the detection of the alignment marker AM in the lane #2.

The control circuit 123c controls the writing of the writing data WD into the RAMs 129a to 129c and the reading of the reading data Dm from the RAMs 129a to 129c. More specifically, the control circuit 123c outputs the writing enable signal ENw and the writing address ADw to the RAM 129a to 129c to control the writing. Moreover, the control circuit 123c outputs the reading enable signal ENr and the reading address ADr to the RAM 129a to 129c to control the reading. After the detection of the alignment marker AM in the lane #0, the control circuit 123c stops the writing of the data D in the other lanes #1 to #3.

When the writing enable signal ENw is “1” (the high level voltage), the data D in the lane #2 from the FFs 120a and 120b is written into the writing address ADw of the RAM 129c as the writing data WD. Moreover, when the reading enable signal ENr “1” (the high level signal), the data D in the lane #2 is read from the reading address ADr of the RAM 129c as the reading data Dm. The reading data Dm is input to the AM detector 121c via the selector 128c.

Moreover, in the control circuit 123c, the bit position signal P and the detection signal Td are input from the AM detector 121c. The control circuit 123c outputs the bit position signal P (#0) in the lane #0 to the latch circuit 124a, and outputs the bit position signal P (#1) in the lane #1 to the latch circuit 126a. The control circuit 123c outputs the bit position signal P (#2) in the lane #2 to the latch circuit 124b, and outputs the bit position signal P (#3) in the lane #3 to the latch circuit 126b.

Moreover, the control circuit 123c outputs the detection signal Td (#0) in the lane #0 to the counter circuit 125a, and outputs the detection signal Td (#1) in the lane #1 to the counter circuit 127a. The control circuit 123c outputs the detection signal Td (#2) in the lane #2 to the counter circuit 125b, and outputs the detection signal Td (#3) in the lane #3 to the counter circuit 127b.

The counter circuits 125a, 127a, 125b and 127b adjust the delay of the alignment markers AM in the lanes #1 to #3 generated by storing the data D into the RAMs 129a to 129c. More specifically, the counter circuit 125a delays the detection signal Td (#0) of the alignment marker AM in the lane #0 by one frame. The counter circuit 127a delays the detection signal Td (#1) of the alignment marker AM in the lane #1 in accordance with a time difference between the alignment markers AM in the lanes #0 and #1, based on the delayed detection signal Td (#0) in the lane #0.

Moreover, the counter circuit 125b delays the detection signal Td (#2) of the alignment marker AM in the lane #2 in accordance with a time difference between the alignment markers AM in the lanes #0 and #2, based on the delayed detection signal Td (#0) in the lane #0. The counter circuit 127b delays the detection signal Td (#3) of the alignment marker AM in the lane #3 in accordance with a time difference between the alignment markers AM in the lanes #0 and #3, based on the delayed detection signal Td (#0) in the lane #0.

When the pulse of the detection signal Td (#0) is input, the counter circuit 125a counts the counter value C (#0) from 0 to the Cm according to the clock signal. When the counter value C (#0) becomes the Cm, the counter circuit 125a outputs the pulse of the detection signal Td′ (#0). The counter circuit 127a acquires the phase difference ΔN between the alignment markers AM in the lanes #0 and #1 from the control circuit 123c, and loads the value shifted by the phase difference ΔN from the counter value C (#0) of the counter circuit 125a to the counter value C (#1) of the counter circuit 127a when the pulse of the detection signal Td (#1) in the lane #1 is input. When the counter value C (#1) becomes the Cm, the counter circuit 127a outputs the pulse of the detection signal Td′ (#1).

The counter circuit 125b acquires the phase difference ΔN between the alignment markers AM in the lanes #0 and #2 from the control circuit 123c, and loads the value shifted by the phase difference ΔN from the counter value C (#0) of the counter circuit 125a to the counter value C (#2) of the counter circuit 125b when the pulse of the detection signal Td (#2) in the lane #2 is input. When the counter value C (#2) becomes the Cm, the counter circuit 125b outputs the pulse of the detection signal Td′ (#2).

The counter circuit 127b acquires the phase difference ΔN between the alignment markers AM in the lanes #0 and #3 from the control circuit 123c, and loads the value shifted by the phase difference ΔN from the counter value C (#0) of the counter circuit 125a to the counter value C (#3) of the counter circuit 127b when the pulse of the detection signal Td (#3) in the lane #3 is input. When the counter value C (#3) becomes the Cm, the counter circuit 127b outputs the pulse of the detection signal Td′ (#3).

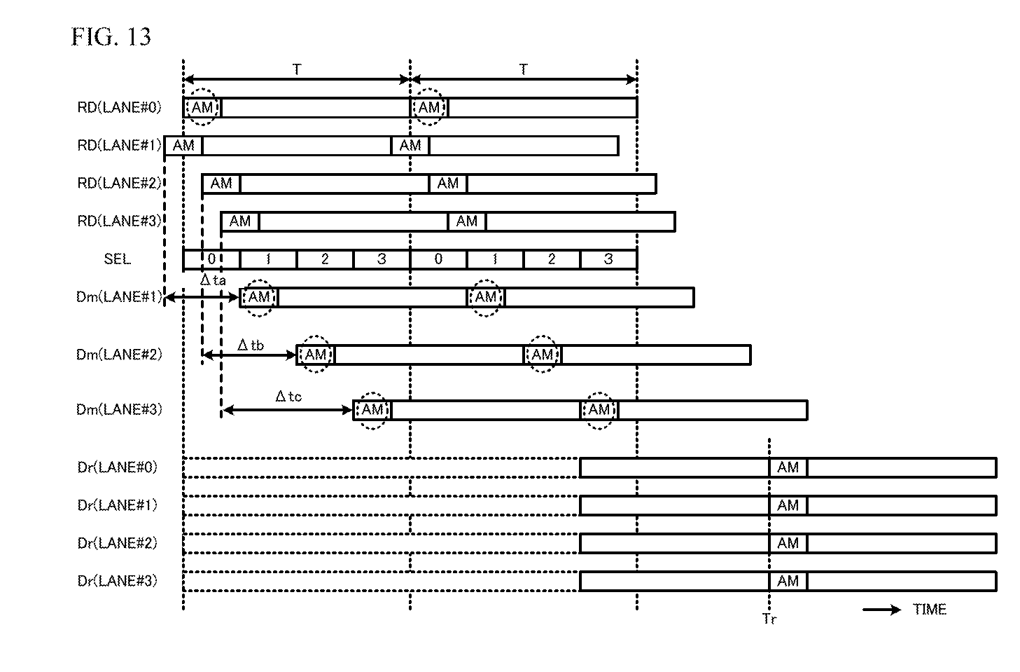

FIG. 13 is a timing chart illustrating the operation of the receiver 1 according to another embodiment. In FIG. 13, description of the operation in common with FIG. 9 is omitted.

In the periods T of the two continuous frames, the AM detector 121c detects the alignment marker AM from the data RD in the lane #2 (see dotted circles). Moreover, the RAM 129a stores the data RD of the lane #1, the RAM 129c stores the data RD of the lane #2, and the RAM 129b stores the data RD of the lane #3.

The control circuit 123c makes the selection signal SEL into “0” so that the data RD in the lane #0 is input to the AM detector 121c. After the AM detector 121c detects the alignment marker AM in the lane #0, the control circuit 123c makes the selection signal SEL into “1” so that the data RD in the lane #1 stored into the RAM 129a is input to the AM detector 121c.

In the periods T of the two continuous frames, the AM detector 121c detects the alignment marker AM in the lane #1 from the reading data Dm of the RAM 129a (see dotted circles). The alignment marker AM in the reading data Dm has a delay time Δta due to the RAM 129a against the alignment marker AM of the original data RD.

After the AM detector 121c detects the alignment marker AM in the lane #1, the control circuit 123c makes the selection signal SEL into “2” so that the data RD in the lane #2 is input to the AM detector 121c. In the periods T of the two continuous frames, the AM detector 121c detects the alignment marker AM in the lane #2 from the reading data Dm of the RAM 129b (see dotted circles). The alignment marker AM in the reading data Dm has a delay time Δtb due to the RAM 129b against the alignment marker AM of the original data RD.

After the AM detector 121c detects the alignment marker AM in the lane #2, the control circuit 123cc makes the selection signal SEL into “3” so that the data RD in the lane #3 is input to the AM detector 121c. In the periods T of the two continuous frames, the AM detector 121c detects the alignment marker AM in the lane #3 from the reading data Dm of the RAM 129c (see dotted circles). The alignment marker AM in the reading data Dm has a delay time Δtc due to the RAM 129c against the alignment marker AM of the original data RD.

Thus, since the alignment markers AM in the reading data Dm have the delay times Δta to Δtc, the counter circuits 125a, 127a, 125b and 127b adjust the detection signals Td (#0) to Td (#3) based on the delay times Δta to Δtc.

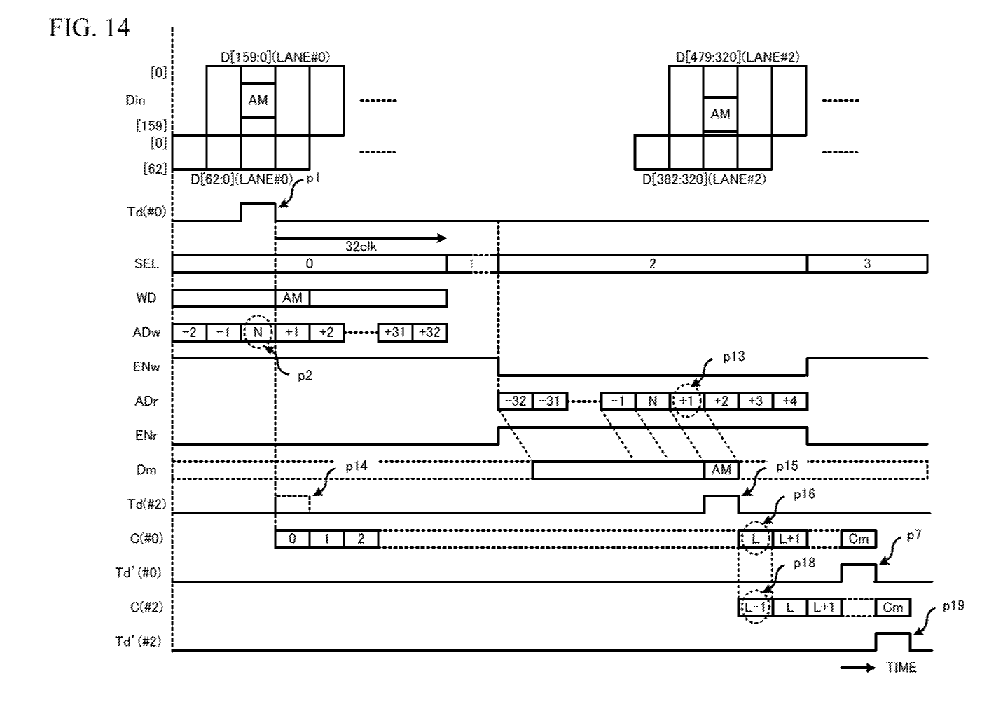

FIG. 14 is a timing chart illustrating the operation of the marker lock part 12 according to the another embodiment. In FIG. 14, the timing adjustment of the detection signal Td (#2) in the lane #2 is illustrated, but the timing adjustment of the detection signal Td (#3) in the lane #3 is also performed in a similar way. In FIG. 14, description of the operation in common with FIG. 10 is omitted.

In the present example, it is assumed that the alignment markers AM in the lane #0 is earlier by one clock than the alignment markers AM in the lane #1. The storage area of the RAM 129c is 64 words as an example, but is not limited to this.

After the detection of the alignment markers AM in the lane #1, the control circuit 123a makes the selection signal SEL into “2”, makes the reading enable signal ENr for the RAM 129c into “1”, and begins the output of the reading address ADr. The control circuit 123c counts the reading address ADr from “−32”.

Thereby, the reading data Dm is read from the RAM 129c, and is input to the AM detector 121c as the data Din. Here, the reading data Dm is delayed by one clock from the reading address ADr, and is input to the AM detector 121c.

The AM detector 121c detects the alignment markers AM in the lane #2 from the reading data Dm, and outputs the pulse of the detection signal Td (#2) at the timing (see a code “p15”). The pulse of the detection signal Td (#2) delays from the timing of the alignment marker AM in the original lane #2 (see a code “p14”). To adjust the delay, the counter circuit 125b adjusts the timing of the detection signal Td (#2) and makes it into the detection signal Td′ (#2).

Moreover, when the pulse of the detection signal Td (#2) in the lane #2 is input from the AM detector 121c, the control circuit 123c detects the reading address ADr into which the alignment marker AM is stored. Since the reading data Dm delays from the reading address ADr by one clock, the control circuit 123c detects the reading address ADr before one clock from the alignment marker AM in the reading data Dm. In the present example, the alignment marker AM in the lane #2 is later than the alignment marker AM in the lane #0 by one clock on a time axis, and therefore “+1” is detected as the reading address ADr (see a code “p13”).

After the control circuit 123c detects the reading address ADr corresponding to the alignment marker AM in the lane #2, the control circuit 123a makes the writing enable signal ENw into “1” again. Thereby, the data D in the lane #2 begins to be stored into the RAM 129c again.

Moreover, the control circuit 123c outputs the reading address ADr corresponding to the alignment marker AM in the lane #2 to the counter circuit 125b as the phase difference ΔN with respect to the reference address N. When the pulse of the detection signal Td (#2) is input from the AM detector 121c via the control circuit 123c, the counter circuit 125b acquires the counter value C (#0) from the counter circuit 125a, and loads a value shifted by the phase difference ΔN from the counter value C (#0), to the counter value C (#2) of the counter circuit 125b.

In the present example, the phase difference ΔN is “+1”. Therefore, when the counter value C (#0) in a next clock cycle when the pulse of the detection signal Td (#2) is input is L (a positive integer) (see a code “p16”) for example, “L−1” is loaded to the counter value C (#2) (see a code “p18”). That is, a value delayed from the counter value C (#0) by one clock is loaded to the counter value C (#2).

When the counter value C (#2) becomes the Cm, the counter circuit 125b outputs the pulse of the detection signal Td′ (#2) in the lane #2 (see a code “p19”). Since the counter value C (#2) is later by one clock than the counter value C (#0) depending on the phase difference ΔN, the pulse of the detection signal Td′ (#2) in the lane #2 is delayed from the detection signal Td′ (#0) in the lane #0 by one clock and is output. Thereby, the delay of the data RD in the lane #2 is adjusted.

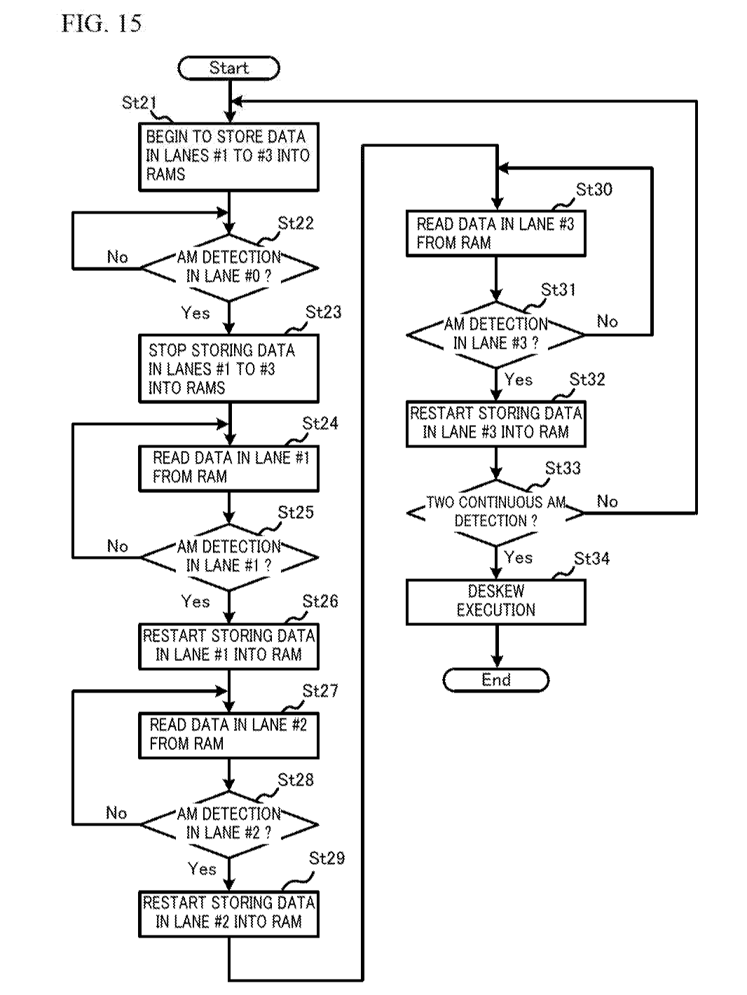

FIG. 15 is a flowchart illustrating the operation of the receiver 1 according to the another embodiment. The control circuit 123c begins to store the data D (the writing data WD) in the lanes #1 to #3 into the RAMs 129a to 129c according to the writing enable signal ENw and the writing address ADw (step St21).

Next, the control circuit 123c determines whether the alignment marker AM in the lane #0 is detected based on the detection signal Td from the AM detector 121c (step St22). When the alignment marker AM in the lane #0 is not detected (No in step St22), the processing of step St22 is performed again.

When the alignment marker AM in the lane #0 is detected (Yes in step St22), the control circuit 123c stops storing the data D in the lanes #1 to #3 into the RAMs 129a to 129c according to the writing enable signal ENw (step St23). Next, the control circuit 123c reads the data D (the reading data Dm) in the lane #1 from the RAM 129a according to the reading enable signal ENr and the reading address ADr (step St24). The readout data D in the lane #1 is input to the AM detector 121c.

Next, the control circuit 123c determines whether the alignment marker AM in the lane #1 is detected based on the detection signal Td from the AM detector 121c (step St25). When the alignment marker AM in the lane #1 is not detected (No in step St25), the processing of step St24 is performed again. When the alignment marker AM in the lane #1 is detected (Yes in step St25), the control circuit 123c restarts storing the data D (the writing data WD) in the lane #1 into the RAM 129a according to the writing enable signal ENw and the writing address ADw (step St26).

Next, the control circuit 123c reads the data D (the reading data Dm) in the lane #2 from the RAM 129c according to the reading enable signal ENr and the reading address ADr (step St27). The readout data D in the lane #2 is input to the AM detector 121c.

Next, the control circuit 123c determines whether the alignment marker AM in the lane #2 is detected based on the detection signal Td from the AM detector 121c (step St28). When the alignment marker AM in the lane #2 is not detected (No in step St28), the processing of step St27 is performed again. When the alignment marker AM in the lane #2 is detected (Yes in step St28), the control circuit 123c restarts storing the data D (the writing data WD) in the lane #2 into the RAM 129c according to the writing enable signal ENw and the writing address ADw (step St29).

The control circuit 123c reads the data D (the reading data Dm) in the lane #3 from the RAM 129b according to the reading enable signal ENr and the reading address ADr (step St30). The readout data D in the lane #3 is input to the AM detector 121c.

Next, the control circuit 123c determines whether the alignment marker AM in the lane #3 is detected based on the detection signal Td from the AM detector 121c (step St31). When the alignment marker AM in the lane #3 is not detected (No in step St31), the processing of step St30 is performed again. When the alignment marker AM in the lane #3 is detected (Yes in step St31), the control circuit 123c restarts storing the data D (the writing data WD) in the lane #3 into the RAM 129b according to the writing enable signal ENw and the writing address ADw (step St32).

Next, the lock judging circuit 132 determines whether the alignment marker AM in each of the lanes #0 to #3 is detected twice (step St33). When the alignment marker AM in each of the lanes #0 to #3 is not detected twice (No in step St33), the processing of step St21 is performed again.

When the alignment marker AM in each of the lanes #0 to #3 is detected twice (Yes in step St33), the reading counter circuit 133 outputs the reading address to the RAMs (#0 to #3) 131 in the lanes #0 to #3, to thereby execute the deskew processing (step St34). In this way, the receiver 1 operates.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention.

What is claimed is:

1. A transmission apparatus comprising:
a first transferer that transfers first data including first identification information;
a second transferer that transfers second data including second identification information;
a detector that detects the first identification information from the first data transferred from the first transferer; and
a storage that stores the second data transferred from the second transferer;
wherein the detector detects the second identification information from the second data stored into the storage after detecting the first identification information from the first data.

2. The transmission apparatus as claimed in claim 1, further comprising:
a third transferer that transfers third data including third identification information;
wherein the storage stores the third data, and
the detector detects the third identification information from the third data stored into the storage after detecting the second identification information from the second data.

3. The transmission apparatus as claimed in claim 1, further comprising:
an adjuster that adjusts a skew between the first transferer and the second transferer based on each of timings in which the first identification information and the second identification information are detected by the detector.

4. A detection method implemented by a transmission apparatus including a detector, a first transferer, a second transferer and a storage, the detection method comprising:
detecting, by the detector, first identification information from first data transferred from the first transferer;
storing second data transferred from the second transferer into the storage;
detecting, by the detector, second identification information from the second data stored into the storage after the first identification information is detected from the first data.

5. The detection method as claimed in claim 4, wherein
the storing stores into the storage third data transferred from a third transferer included in the transmission apparatus,
the detection method further comprising:
detecting, by the detector, third identification information from the third data stored into the storage after the second identification information is detected from the second data.

6. The detection method as claimed in claim 4, further comprising:
adjusting, by an adjuster included in the transmission apparatus, a skew between the first transferer and the second transferer based on each of timings in which the first identification information and the second identification information are detected.
